(19) United States
(12) Patent Application Publication
(10) Pub. No.: US 2019/0248319 A1
(43) Pub. Date: Aug. 15, 2019

(54) AIRBAG LID AND METHOD OF MANUFACTURING THE SAME

(71) Applicant: CALSONIC KANSEI CORPORATION, Saitama (JP)

(72) Inventors: Shunji HIRAKI, Saitama (JP); Kenzi HATSUMI, Saitama (JP); Takahiro SEKIZAWA, Saitama (JP); Takashi KUDOU, Saitama (JP)

(73) Assignee: CALSONIC KANSEI CORPORATION, Saitama (JP)

(21) Appl. No.: 16/336,895

(22) PCT Filed: Sep. 12, 2017
(86) PCT No.: PCT/JP2017/032899

§ 371 Date: Mar. 26, 2019

(30) Foreign Application Priority Data
Sep. 27, 2016 (JP) 2016-187700

(51) Int. Cl. B60R 21/205; B60R 21/2165

(52) U.S. Cl. CPC B60R 21/205; B60R 2021/21537; B60R 21/2165

(57) ABSTRACT

To improve the positioning accuracy of a reinforcing member relative to a cutting line. An airbag lid includes an airbag lid main body having a positioning reference portion and a cutting line positioned relative to the positioning reference portion, and a reinforcing member attached to the airbag lid main body to surround the cutting line. The reinforcing member is positioned relative to the positioning reference portion.

### CROSS-REFERENCE TO RELATED APPLICATION

The present application is a 371 Application based on PCT/JP2017/032899 filed Sep. 12, 2017, and claims priority to Japanese patent application No. 2016-187700, filed Sep. 27, 2016, the disclosures of which are hereby incorporated by reference herein in their entirety.

### TECHNICAL FIELD

The present disclosure relates to an airbag lid and a method of manufacturing the same.

### BACKGROUND ART

An instrument panel is installed in a front portion of an interior of a vehicle such as an automobile.

An airbag device for a front passenger seat is installed in a part of the instrument panel to face the front passenger seat as a safety device for protecting a front passenger in case of emergency (see JP2015-205592A, for example).

This airbag device includes an airbag module and an airbag lid. The airbag module houses a folded airbag main body to develop the airbag main body in case of emergency. The airbag lid usually covers the airbag module, and opens by a pressure force of the developed airbag main body in case of emergency to form an opening portion through which the airbag main body swells into the interior of the vehicle.

The airbag lid includes an airbag lid main body having, on a rear surface thereof, a cutting line. A reinforcing member is attached to the rear surface of the airbag lid main body to overlap with the surrounding of the cutting line.

### SUMMARY

However, the above airbag lid has the following problem. The cutting line and the reinforcing member are individually positioned relative to the airbag lid main body. For this reason, the reinforcing member may not be accurately positioned relative to the cutting line.

An main object of the present disclosure is to solve the above problem.

To solve the above problem, the present disclosure provides an airbag lid including an airbag lid main body including a positioning reference portion and a cutting line positioned relative to the positioning reference portion, and a reinforcing member attached to the airbag lid main body to surround the cutting line. The positioning reference portion includes a through hole that penetrates through the airbag lid main body in its thickness direction, the reinforcing member includes an end portion and a projection portion extending outside from the end portion toward the through hole, and the projection portion of the reinforcing member is positioned relative to the positioning reference portion including the through hole.

### BRIEF DESCRIPTION OF DRAWINGS

FIG. 1 is an exploded perspective view of an airbag lid according to an embodiment.

FIG. 2 is a longitudinal sectional view of an assembled airbag lid in FIG. 1.

FIG. 3 is a perspective view of a rear surface of the airbag lid in FIG. 2.

FIG. 4 is a bottom view of FIG. 2.

FIG. 5 is a partially enlarged view of FIG. 4.

FIG. 6 is a side view illustrating a cutting line process with a cutting line processor.

FIG. 7 is a side view illustrating a reinforcing member attached with a reinforcing member attachment device.

FIG. 8 is a partially enlarged perspective view illustrating the airbag lid having a hole into which a positioning pin is inserted.

FIG. 9 is a partially enlarged longitudinal sectional view illustrating the airbag lid and the reinforcing member each having a hole into which the positioning pin is inserted (partially enlarged view of FIG. 2).

FIG. 10 is a perspective view of an airbag lid, similar to FIG. 1, to which a panel is attached.

FIG. 11 is a bottom view of the airbag lid, similar to FIG. 4, without a positioning reference portion.

### DESCRIPTION OF EMBODIMENT

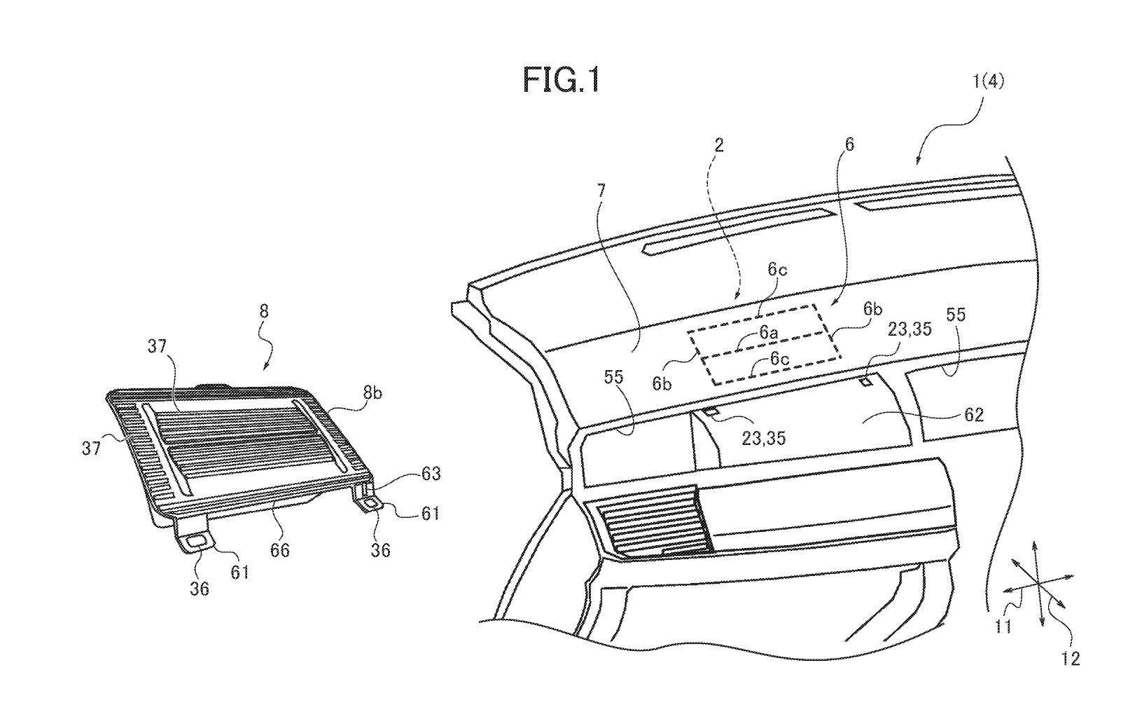

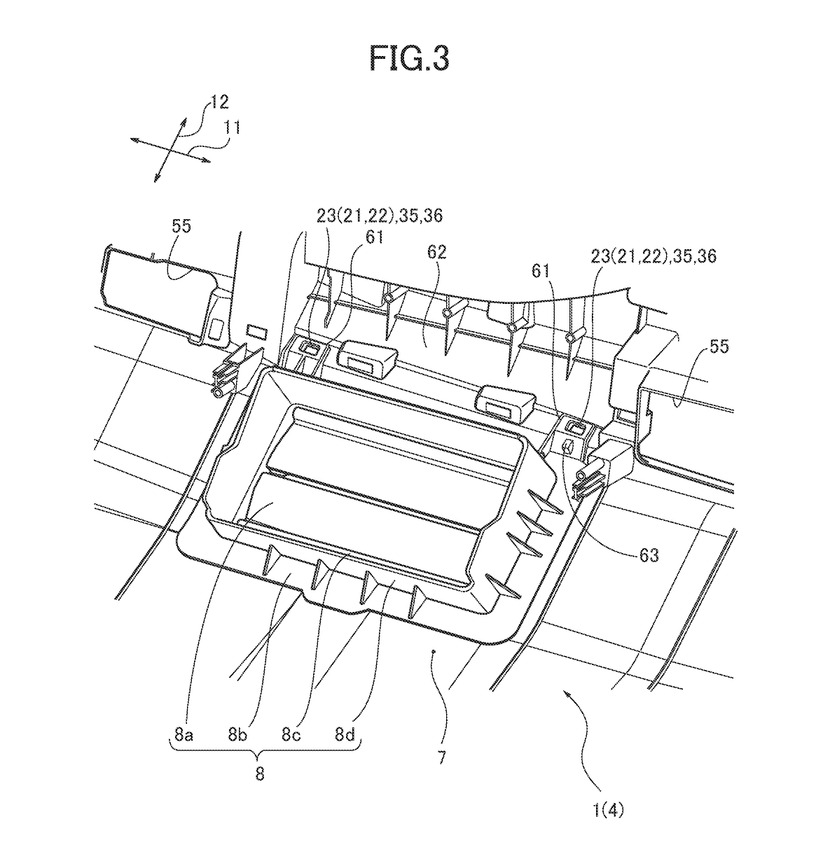

Hereinafter, an embodiment is described in details with reference to the drawings. FIGS. 1-11 are views describing the embodiment.

### Embodiment 1

Hereinafter, the configuration of the embodiment is described.

As illustrated in FIG. 1, an instrument panel 1 is installed in a front portion of an interior of a vehicle such as an automobile.

An airbag device 2 for a front passenger seat is installed in a part of the instrument panel 1 to face the front passenger seat as a safety device for protecting a front passenger in case of emergency.

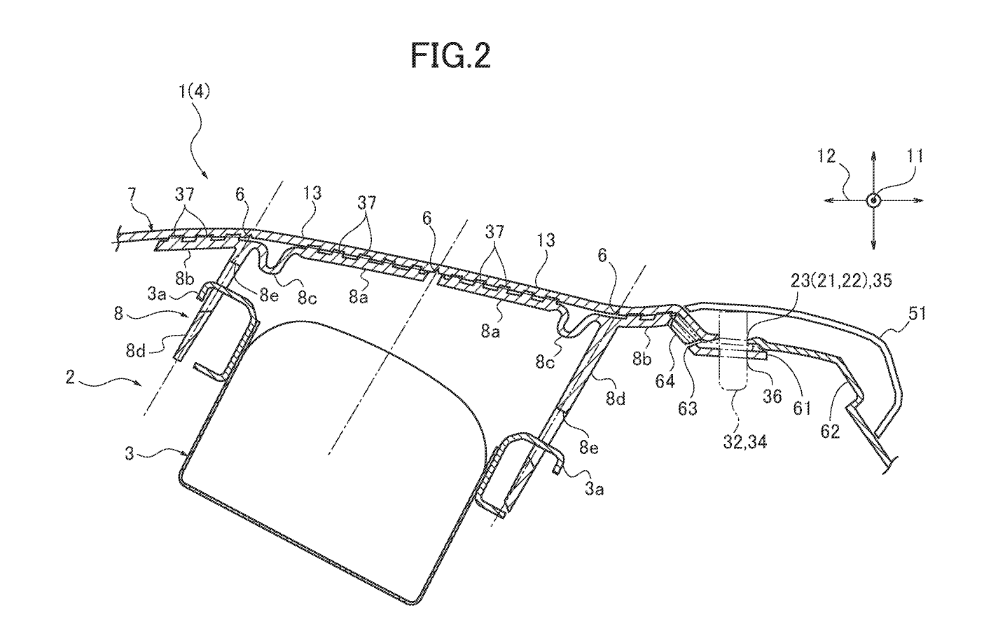

As illustrated in FIG. 2, the airbag device 2 includes an airbag module 3 and an airbag lid 4. The airbag module 3 houses a folded airbag main body. The airbag main body develops in case of emergency. The airbag lid 4 usually covers the airbag module 3. In case of emergency, the airbag lid 4 opens by a pressure force of the developed airbag main body to form an opening portion through which the airbag main body swells into the interior of the vehicle.

The airbag lid 4 includes an airbag lid main body 7 having, on a rear surface thereof, a cutting line 6. A reinforcing member 8 is attached to the rear surface of the airbag lid main body 7 to overlap with the surrounding of the cutting line 6.

The airbag lid 4 may be integrated with the instrument panel 1 (integrated lid) or the airbag lid 4 may be separated from the instrument panel 1 (separated lid). In this embodiment, the airbag lid 4 is integrated with the instrument panel 1. The airbag lid 4 may have a single layer structure consisting of a hard resin or a multi-layer structure having, on a surface of a hard resin core, a soft surface material made of soft resin or leather. An intermediate layer such as a foaming layer and a cushioning layer may be provided between the core and the surface material.

The cutting line 6 is, for example, a groove formed on the rear surface of the airbag lid main body 7. The groove does not penetrate through the airbag lid main body 7. Although the cutting line 6 has various shapes, the cutting line 6 has an approximate H shape in planer view as illustrated in FIG. 1. In this case, the cutting line 6 includes at least a lateral cutting line 6a extending in a substantial vehicle width direction 11 and right and left longitudinal cutting lines 6b extending from both end portions of the lateral cutting line 6a in a substantial vehicle front and back direction 12. The cutting line 6 may have an approximate eight shape in planer view. In this case, the cutting line 6 includes front and back lateral cutting lines 6c connecting both end portions of the longitudinal cutting lines 6b of the cutting line 6 having the approximate H shape in planer view. As illustrated in FIG. 2, two doors 13 capable of opening the opening portion of the airbag lid main body 7 are provided by the cutting line 6 having the approximate H shape or the approximate eight shape in planer view. However, the shape of the cutting line 6 is not limited to the above shape.

The reinforcing member 8 includes a door reinforcing portion 8a that reinforces the door 13 from the rear surface side thereof, a flange portion 8b (outer peripheral reinforcing portion) that reinforces an outer periphery portion of the door 13 from the rear surface side thereof, a hinge portion 8c that connects the flange portion 8b and the door reinforcing portion 8a, and a guide portion 8d (or attachment leg portion) extending oblique forward and downward from an inside rim portion of the flange portion 8b.

The door 13 is a movable portion of the airbag lid main body 7. The outer periphery portion of the door 13 is a non-movable portion of the airbag lid main body 7. The flange portion 8b is a rectangular frame having a long side along the substantial vehicle width direction 11. The hinge portion 8c has a downward extra length. The hinge portion 8c may be made of resin and is integrated with the reinforcing member 8, or may be a member different from the reinforcing member 8. The guide portion 8d houses at least an upper portion of the airbag module 3, and guides the developed airbag main body from the airbag module 3 toward the door reinforcing portion 8a and the door 13.

A plurality of holes 8e is provided in the front and back surfaces of the guide portion 8d at intervals in the vehicle width direction 11. A plurality of hooks 3a provided in the front and back surfaces of the airbag module 3 is loosely fitted into a plurality of holes 8e. The lower portion of the airbag module 3 is fixed to a vehicle body (through a vehicle body reinforcing member such as a steering support member).

The embodiment includes the following configurations in addition to the above basic configurations.

(1) As illustrated in FIGS. 2 to 5, the airbag lid 4 includes the airbag lid main body 7 and the reinforcing member 8. The airbag lid main body 7 includes a positioning reference portion 23 and the cutting line 6 positioned relative to the positioning reference portion 23. The reinforcing member 8 is attached to the airbag lid main body 7 to surround the cutting line 6. The reinforcing member 8 is positioned relative to the positioning reference portion 23 (of the cutting line 6).

More specifically, the airbag lid main body 7 includes a first positioning reference 21 for providing the cutting line 6 and a second positioning reference 22 for attaching the reinforcing member 8. The first positioning reference 21 and the second positioning reference 22 are unified as the common positioning reference portion 23 provided in the same position.

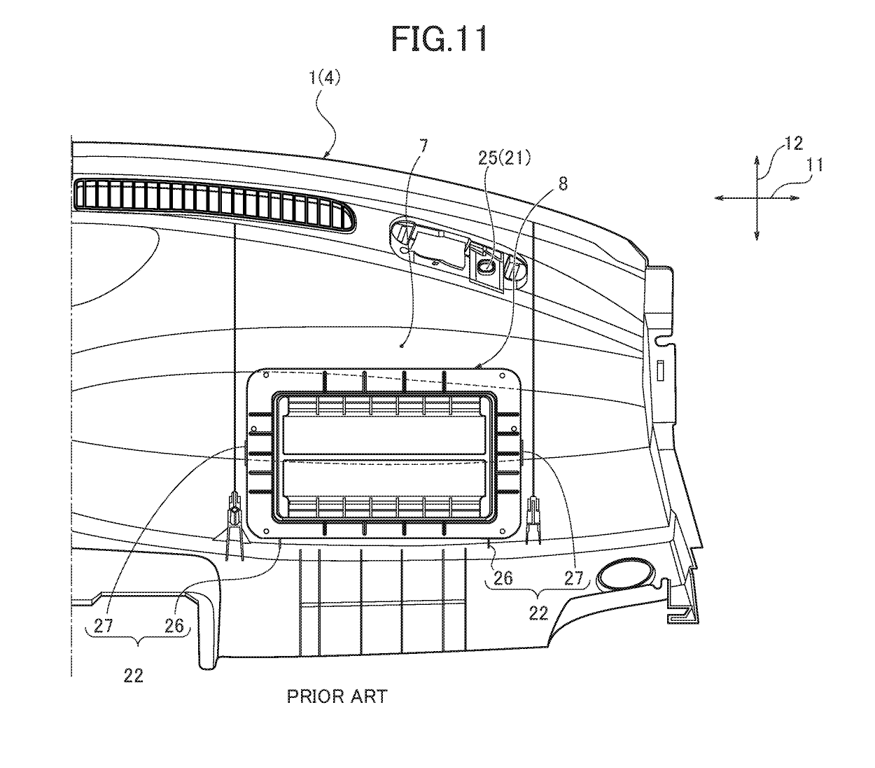

The first positioning reference 21 is typically a positioning hole provided in the airbag lid main body 7. The positioning hole uses one of a plurality of holes 25 (refer to comparative example of FIG. 11) provided in, for example, the end portion of the airbag lid main body 7 for different purposes. Such a hole 25 is often provided away from a position to which the reinforcing member 8 is attached. For example, the hole 25 closest to the attachment position of the reinforcing member 8 is selected among a plurality of holes 25 as the first positioning reference 21.

The second positioning reference 22 is typically positioning ribs 26, 27 (refer to comparative example of FIG. 11) provided on the rear surface of the airbag lid main body 7. The second positioning reference 22 requires the separate positioning ribs 26, 27. Each of the positioning ribs 26, 27 is a rib (positioning rib 26) that positions the reinforcing member 8 relative to the airbag lid main body 7 in the vehicle front and back direction 12 and is a rib (positioning rib 27) that displaces the reinforcing member 8 in the vehicle width direction 11 while controlling the displacement amount.

Namely, in a conventional technique, the first positioning reference 21 and the second positioning reference 22 have different shapes and structures, respectively, and are provided in different positions, respectively.

In contrast, in order to unify the first positioning reference 21 and the second positioning reference 22 as the common positioning reference portion 23, it is necessary to unify the shapes and the structures of the positioning hole and the positioning ribs 26, 27, and to provide them in the same position.

In this case, a reference having the same shape as the first positioning reference 21 is used for the second positioning reference 22, in order to unify the first positioning reference 21 and the second positioning reference 22 as the common positioning reference portion 23.

(2) The positioning reference portion 23 may be a hole 35, and the reinforcing member may include another hole 36. Both of the holes 35, 36 may be provided to be overlapped.

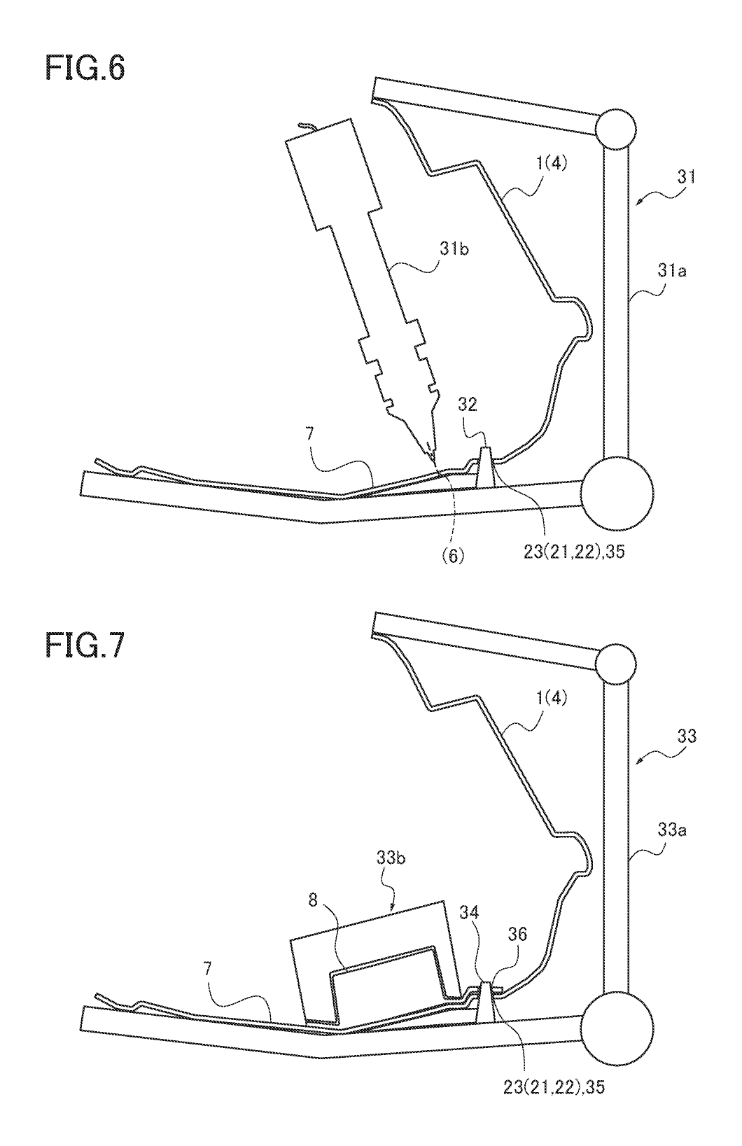

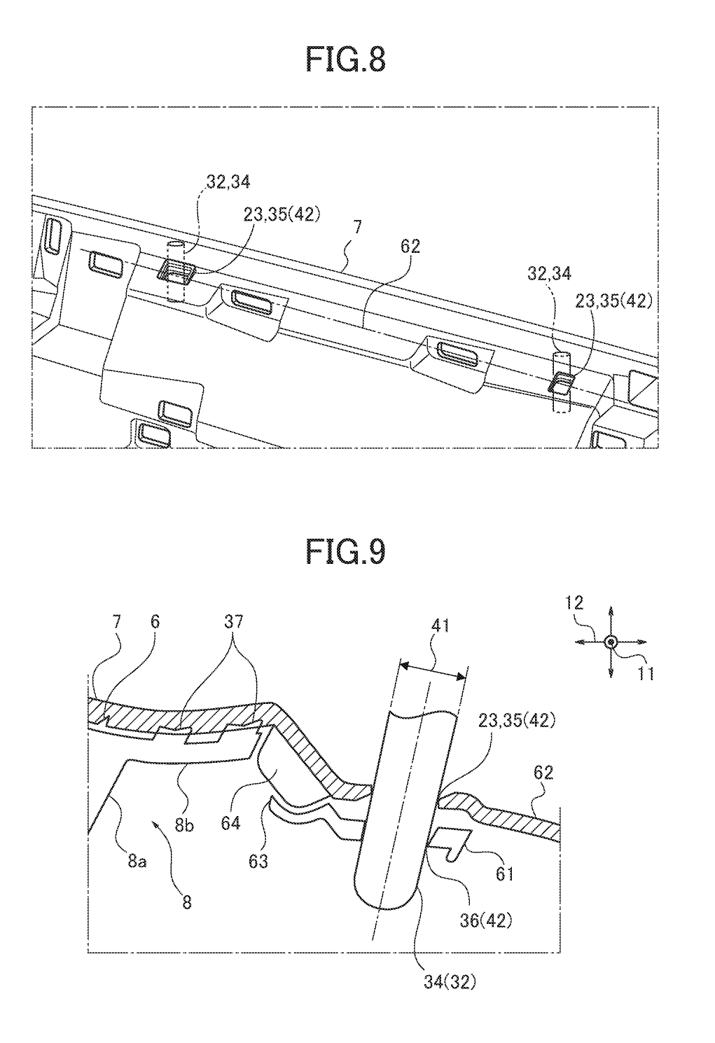

More specifically, the positioning reference portion 23 may be the hole 35 (common hole) into which a positioning pin 32 of a cutting line processor 31 is inserted at the time of processing the cutting line 6, as illustrated in FIG. 6 (FIG. 8), and a positioning pin 34 of a reinforcing member attachment device 33 is inserted at the time of attaching the reinforcing member 8, as illustrated in FIG. 7 (FIG. 8). Moreover, as illustrated in FIG. 9, the reinforcing member 8 may be provided with another hole 36 into which the positioning pin 34 of the reinforcing member attachment device 33 is inserted.

The cutting line processor 31 may be a laser processor, a rotation processor such as an end mill, or another device. The cutting line processor 31 includes at least a processing post 31a and a processing jig 31b (for example, laser torch).

The reinforcing member attachment device 33 may be a vibration welder. The reinforcing member attachment device 33 includes at least a processing post 33a and a processing jig 33b (vibration jig). The processing post 31a of the cutting line processor 31 and the processing post 33a of the reinforcing member attachment device 33 may be the common post.

When the reinforcing member attachment device 33 is the vibration welder, the reinforcing member 8 is fixed to the airbag lid main body 7 by the vibration welding. In order to perform the vibration welding, a welding rib 37 (FIG. 9) is integrated with the top surfaces of the flange portion 8b of the reinforcing member 8 and the door 13. The welding rib 37 extends in one direction toward the vibration direction in the vibration welding. In this case, the vibration direction is, for example, the vehicle width direction 11. A plurality of welding ribs 37 is provided in parallel at intervals in a direction 39 (in this case, vehicle front and back direction 12) orthogonal to the vibration direction. However, the vibration direction is not limited to the above, and may be, for example, the vehicle front and back direction 12 or another direction.

The positioning pin 32 of the cutting line processor 31 and the positioning pin 34 of the reinforcing member attachment device 33 have circular cone shapes or pyramid shapes each having the same size, or cylindrical shapes or prismatic column shapes each having the same size.

The hole 35 of the airbag lid main body 7 may be a through hole that penetrates through the airbag lid main body 7 in its thickness direction or a boss projecting from the rear surface of the airbag lid main body 7. Similarly, the hole 36 of the reinforcing member 8 may be a through hole that penetrates through the reinforcing member 8 in its thickness direction or a boss projecting from the front surface or the rear surface of the reinforcing member 8.

(3) At least one of the hole 35 and the hole 36 may be a long hole 42 extending in one direction.

The long hole 42 may have a width 41 which is the same as the diameter of the positioning pins 32, 34. This long hole 42 may extend in the direction relatively moving the airbag lid main body 7 and the reinforcing member 8 with the reinforcing member attachment device 33.

The other of the hole 35 and the hole 36 may be a circle hole or a square hole having the width 41 which is substantially the same as the diameter of the positioning pins 32, 34. The diameters of the positioning pins 32, 34 are based on the diameters of parts of the positioning pins 32, 34 to be fitted into the hole 35 and the hole 36. The width 41 of the hole 35 and the hole 36 which is the same as the diameters of the positioning pins 32, 34 provides a function of positioning of the positioning pins in the directions other than the extending direction of the long hole 42. By providing a plurality of holes 35 and positioning pins 32, 34, the reinforcing member 8 is controlled from moving in the rotation direction relative to the surface of the airbag lid main body 7.

The direction in which relatively moves the airbag lid main body 7 and the reinforcing member 8 is the vibration direction of the reinforcing member attachment device 33 (vibration welder). In this case, as the vibration direction of the vibration welder is the vehicle width direction 11, the long hole 42 extends in the vehicle width direction 11 (direction orthogonal to the surface of FIG. 9).

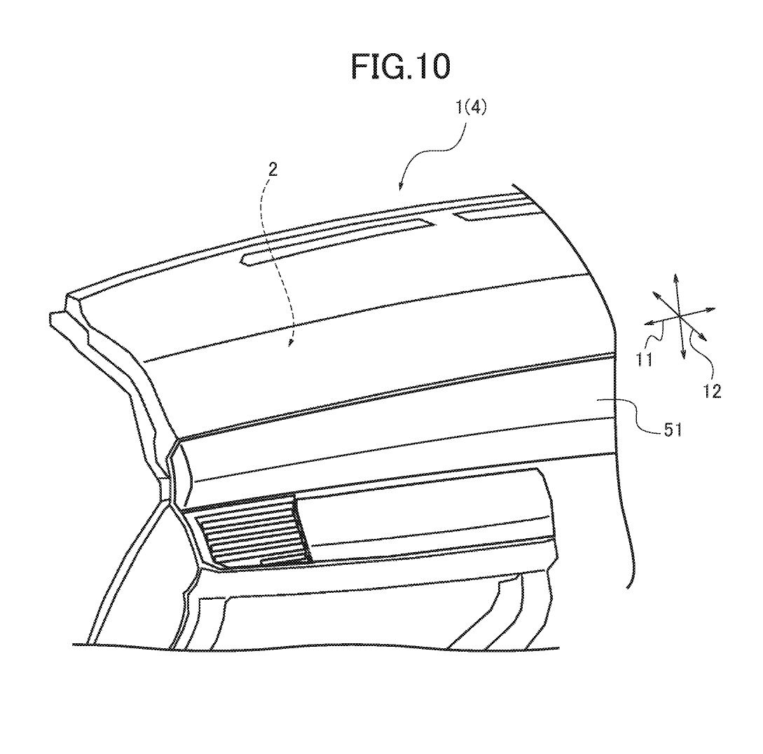

(4) As illustrated in FIG. 10 (also refer to FIG. 1), the positioning reference portion 23 may be covered by a panel 51 attached to the front surface of the airbag lid main body 7.

The panel 51 may be a finisher panel that is partially attached to the front surface of the instrument panel 1. This finisher panel is fixed to the instrument panel 1 by a claw or a screw. In this case, the panel 51 is attached to the upper position of the back portion of the instrument panel 1 (approximate boarder portion of top surface and rear surface of instrument panel 1) to face the front passenger seat. The panel 51 is located close to the airbag device 2 for a front passenger seat. The panel 51 is attached to the instrument panel 1 to cover the opening portion 55 (FIG. 1) provided in the instrument panel 1.

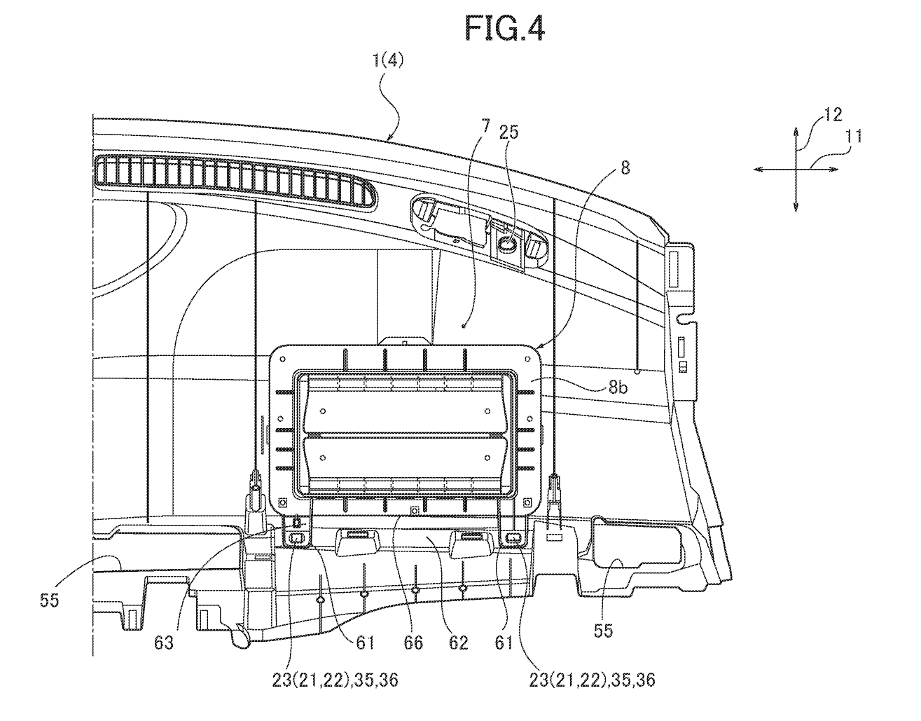

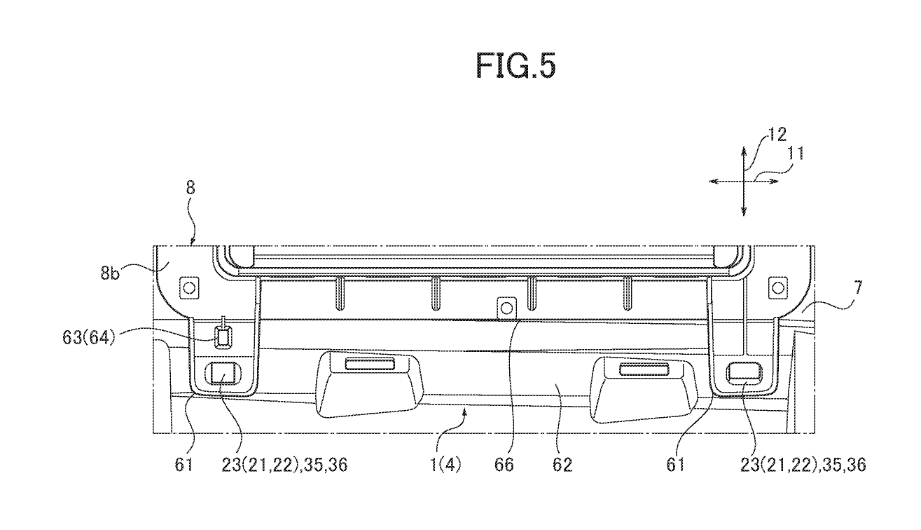

The further specific configuration is described. As illustrated in FIG. 4 (FIG. 5), it is preferable to locate the positioning reference portion 23 outside the reinforcing member 8 attached to the airbag lid main body 7 to be near the reinforcing member 8 attached to the airbag lid main body 7.

For this, a projection portion 61 extends outside the reinforcing member 8 from the end portion of the reinforcing member 8 (flange portion 8b). The above-described hole 36 is provided in the projection portion 61. The hole 35 is provided in the airbag lid main body 7 to overlap with the hole 36.

Next, the positioning reference portion 23 is set in the opening portion 55 covered by the panel 51. The projection portion 61 extends toward the opening portion 55. A secondary structure surface 62 that partially reinforces the opening portion 55 is provided in the opening portion 55 in the airbag lid main body 7. The hole 35 is provided in the secondary structure surface 62. For example, the secondary structure surface 62 may be provided to project from one end portion of the opening portion 55, or may be provided to connect the facing end portions of the opening portion 55. In this case, the secondary structure surface 62 is provided to connect the upper and lower end portions of the opening portion 55 to divide the opening portion 55 into left and right.

Since the hole 35 is provided in the opening portion 55 of the airbag lid main body 7 so as to use the opening portion 55, which is covered by the panel 51, for the positioning reference portion 23, the positioning reference portion 23 is covered by the panel 51 and is easily determined. As a result, it eliminates the need for providing an extra hole in the airbag lid body 7.

As the distance between the hole 35 as the positioning reference portion 23 and the processing position of the cutting line 6 and the distance between the hole 35 and the attachment position of the reinforcing member 8 decrease, the hole 35 is more accurately provided. By providing the hole 35 in the opening portion 55 which is covered by the panel 51, the positioning accuracy of the reinforcing member 8 relative to the cutting line 6 is improved.

As illustrated in FIG. 9, the projection portion 61 may be provided with a position control hole 63, and the secondary structure surface 62 of the airbag lid main body 7 may be provided with a position control rib 64 capable of fitting into the position control hole 63. The position control hole 63 and the position control rib 64 control the positioning of the positioning pin relative to the extending direction (vehicle width direction 11) of the long hole 42. In this case, the position control hole 63 and the position control rib 64 extend in the vehicle front and back direction 12 to control the position of the positioning pin in the vehicle width direction 11. In addition, the position control hole 63 may be a hole having a bottom or may be a through hole.

In this case, the position control hole 63 has a size which is substantially the same as the width of the position control rib 64, so that the position control rib 64 is tightly fitted into the position control hole 63. The width (thickness) of the position control rib 64 is set to thin enough to bend in the vibration welding. Such a width allows the reinforcing member 8 to relatively move in the vibration direction when attaching the reinforcing member 8 by the vibration welding.

As illustrated in FIG. 4 (FIG. 5), the hole 35 and the hole 36 (projection portion 61) are provided along only one side 66 of the reinforcing member 8 (flange portion 8b) having a rectangular shape in a planer view. In this case, a plurality (two) of the holes 35 and a plurality (two) of the holes 36 are provided along the one side 66 at intervals. In this case, a pair of the holes 35 and a pair of the holes 36 are provided with respect to only the both end portions of the back end portion (side 66) of the reinforcing member 8 in the vehicle width direction, respectively. By providing, along only one side of the reinforcing member 8, a plurality of the holes 35 and a plurality of the holes 36, the holes 35 and the holes 36 can be provided in a narrow range while maintaining the positioning operation with the holes 35 and the holes 36. The structures of the airbag lid main body 7 and the positioning reference portion 23 are therefore simplified. The number of position control ribs 64 is also reduced.

(5) The method of manufacturing the above-described airbag lid 4 is described. The method of manufacturing the airbag lid 4 includes a step of providing the cutting line 6 on the rear surface of the airbag lid main body 7 with the cutting line processor 31, and a step of attaching the reinforcing member 8 on the rear surface of the airbag lid main body 7 provided with the cutting line 6 to overlap with the surrounding of the cutting line 6 with the reinforcing member attachment device 33. The cutting line processor 31 is positioned relative to the positioning reference portion 23 provided in the airbag lid main body 7. The reinforcing member attachment device 33 is also positioned relative to the positioning reference portion 23.

In this case, the first positioning reference 21 and the second positioning reference 22 are unified as the common positioning reference portion 23 provided in the same position. The cutting line processor 31 and the reinforcing member attachment device 33 are thereby positioned relative to the same position.

<Operation> Hereinafter, the operation of the embodiment is described.

In case of emergency, the airbag main body develops from the airbag module 3, the airbag main body presses the airbag lid main body 7, and breaks the cutting line 6 provided in the airbag lid main body 7 to form the opening portion 55 in the airbag lid main body 7 and to swell from the opening portion 55 into the interior of the vehicle. The airbag device 2 therefore protects an upper half of a body of a passenger appropriately seated on a front passenger seat.

In the above-described airbag device 2, the cutting line 6 is provided in the airbag lid main body 7 with the cutting line processor 31. The reinforcing member 8 is attached to the airbag lid main body 7 provided with the cutting line 6 with the reinforcing member attachment device 33.

In this case, the cutting line processor 31 provides the cutting line 6 in the airbag lid main body 7 with the first positioning reference 21 set to the airbag lid main body 7. The reinforcing member attachment device 33 attaches the reinforcing member 8 to the airbag lid main body 7 with the second positioning reference 22 set to the airbag lid main body 7.

However, as illustrated in FIG. 11, when the first positioning reference 21 and the second positioning reference 22 are separately set to the airbag lid main body 7, the reinforcing member 8 may not be accurately attached relative to the cutting line 6.

<Effect> According to the embodiment, the following effects are obtained.

(Effect 1) The airbag lid 4 includes the airbag lid main body 7 having the positioning reference portion 23 and the cutting line 6 positioned to the positioning reference portion 23, and the reinforcing member 8 attached to the airbag lid main body 7 to surround the cutting line 6. The reinforcing member 8 is positioned relative to the positioning reference portion 23. More specifically, the first positioning reference 21 for providing the cutting line 6 in the airbag lid main body 7 and the second positioning reference 22 for attaching the reinforcing member 8 to the airbag lid main body 7 are unified as the common positioning reference portion 23. The variations in the attachment position of the reinforcing member 8 relative to the cutting line 6 caused by the different positioning references are thereby prevented. As a result, the positioning accuracy of the reinforcing member 8 relative to the cutting line 6 is improved. The development performance of the airbag main body is also improved by improving the positional accuracy of the reinforcing member 8 relative to the cutting line 6 provided in the airbag main body.

The first positioning reference 21 and the second positioning reference 22 are unified as the common positioning reference portion 23, so that the structure of the airbag lid main body 7 and the like are simplified.

(Effect 2) As described above, the positioning reference portion 23 is formed by the hole 35 and the reinforcing member 8 includes the hole 36. The holes 35, 36 may be overlapped. The cutting line 6 is processed by inserting the positioning pin 32 of the cutting line processor 31 into the hole 35 as the positioning reference portion 23. The reinforcing member 8 is attached by inserting the positioning pin 34 of the reinforcing member attachment device 33 into the hole 35 as the positioning reference portion 23 and inserting the positioning pin 34 of the reinforcing member attachment device 33 into the hole 36 provided in the reinforcing member 8.

(Effect 3) As described above, at least one of the hole 35 and the hole 36 may be the long hole 42 extending in one direction. The long hole 42 allows the airbag lid main body 7 and the reinforcing member 8 to relatively move in one direction when the reinforcing member 8 is attached to the airbag lid main body 7 with the reinforcing member attachment device 33. In this case, the long hole 42 has the size which is the same as the width 41 of the positioning pins 32, 34, which prevents the looseness in the relative movement of the airbag lid main body 7 and the reinforcing member 8.

(Effect 4) In the above, the positioning reference portion 23 may be covered by the panel 51 from the front surface of the airbag lid main body 7. The positioning reference portion 23 is thereby covered by the panel 51 when the airbag lid main body 7 is installed in the vehicle body.

(Effect 5) According to the manufacturing method of the airbag lid 4, the effects similar to the above are obtained.

What is claimed is:

1. An airbag lid comprising:
an airbag lid main body including a positioning reference portion and a cutting line positioned relative to the positioning reference portion; and
a reinforcing member attached to the airbag lid main body to surround the cutting line, wherein
the positioning reference portion includes a through hole that penetrates through the airbag lid main body in its thickness direction,
the reinforcing member includes an end portion and a projection portion extending outside from the end portion to the through hole, and
the projection portion of the reinforcing member is positioned relative to the positioning reference portion including the through hole.

2. The airbag lid according to claim 1, wherein
the through hole of the positioning reference portion is a first hole,
the projection portion of the reinforcing member includes a second hole, and
both of the first and second holes are overlapped to each other.

3. The airbag lid according to claim 2, wherein
at least one of the first hole and the second hole is a long hole extending in one direction.

4. The airbag lid according to claim 1, wherein
the positioning reference portion is covered by a panel attached to a front surface of the airbag lid main body.

5. A method of manufacturing an airbag lid, comprising:
providing a cutting line on a rear surface of the airbag lid main body with a cutting line processor;
positioning the cutting line processor relative to the positioning reference portion provided in the airbag lid main body; and
positioning the reinforcing member attachment device relative to the positioning reference portion.

6. The airbag lid according to claim 1,
wherein a plurality of the projection portions and a plurality of the through holes are provided along only one side of the reinforcing member at intervals.

7. The airbag lid according to claim 1,
wherein the projection portion is provided with a position control hole and the airbag lid main body is provided with a position control rib that is fitted into the position control hole, and
the position control rib is bendable.
